(19) United States
(12) Patent Application Publication
(10) Pub. No.: US 2016/0207801 A1
(43) Pub. Date: Jul. 21, 2016

(54) Systems and Methods for Conditioning Water

(71) Applicant: Basic Water Solutions, LLC, Kerrville, TX (US)

(72) Inventor: Steven J. Stronczek, Harper, TX (US)

(73) Assignee: Basic Water Solutions, LLC, Kerrville, TX (US)

(21) Appl. No.: 14/996,188

(22) Filed: Jan. 14, 2016

Related U.S. Application Data
(60) Provisional application No. 62/104,564, filed on Jan. 16, 2015.
(60) Provisional application No. 62/202,470, filed on Aug. 7, 2015.

(51) Int. Cl. C02F 1/48

(52) U.S. Cl. CPC C02F 1/487

(57) ABSTRACT

A treatment device for treating water with an electromagnetic field comprises a conduit, a transducer comprising a wire coil positioned around an outside of a portion of the conduit, and a controller electrically coupled to the transducer. The controller is configured to provide an alternating current to the transducer. In some instances, the treatment device can include a multi-section transducer comprising a plurality of wire coils positioned around an outside of a portion of the conduit. The plurality of wire coils can be connected in series, and a controller can be electrically coupled to the multi-section transducer. The controller can be configured to provide an alternating current to each wire coil of the plurality of wire coils.

### CROSS-REFERENCE TO RELATED APPLICATIONS

This application claims priority to U.S. Provisional Patent Application No. 62/104,564 filed on Jan. 16, 2015 to Steven Stronczek and entitled “Water Conditioning Device,” as well as claiming priority to U.S. Provisional Patent Application No. 62/202,470 filed on Aug. 7, 2015 to Steven Stronczek and entitled “Systems and Methods for Conditioning Water,” both of which are incorporated herein by reference in their entireties.

### BACKGROUND

Until now, methods of treating water have used relatively low power level, and as a result, have been unsuccessful at maintaining the water in the altered state effected by the applied power. The water remained in the altered state for several hours, sometimes up to a day or two, but was unstable and return back to its untreated condition. Furthermore, traditional methods measure the resulting product in liters per hour and are able to produce only about two liters per hour. For example, KANGEN WATER produces a conditioned water that may have a shelf life of 4-5 days.

Past devices have been unsuccessful at producing a stable, conditioned water for two main reasons. First, a relatively low power is applied to the water to reduce the overall power consumption cost. Second, a metallic conductor is the standard device used to apply power to the water, and it is actually immersed in the water in order to excite the water and pass the electricity through it. The result of this method is an unstable conditioned water that does not maintain its altered state and contains leached metal ions. Not only does the treated water dissipate within days, but the treated water also contains added metal ions.

The amount of power that can be supplied to a water treatment device has been limited. In general, there was no need to apply more power because the goal of producing conditioned drinking water had been reached. Further, a standard 110 volt line from the wall was used, and a 220 volt line was undesirable. Still Further, the amount of amperage applied is limited because of standard electrical system limits. The addition of too much power was undesirable because the electricity was in direct contact with the water via the conductor. If too much power was directly applied to the water, the water would heat up and vaporize, eventually evaporating entirely.

Another device for treating was includes a traditional ion exchange water softener, which has several drawbacks including the addition of sodium ions (Na⁺) to the water, the price of materials that must be constantly replenished, the downtime during the regeneration of the media, and the wasting of water. In a traditional water softener, the media in the tank are charged beads, which can usually hold up to about 30,000 grains of calcium (Ca) and magnesium (Mg). As the water flows through the softener, the Ca and Mg, and other metal cations, present in the water are retained by the media in order to reduce the hardness of the water to essentially zero. Before the media is at capacity, the water softener unit regenerates by adding sodium chloride (NaCl) or potassium chloride (KCl) to the tank in order to cause the media to release the Ca and Mg cations via ion exchange, and the Ca and Mg cations bind with the Cl anions to form calcium chloride (CaCl₂) and magnesium chloride (MgCl₂) in order to be expelled from the unit. The media retains the Na (or K) cations from the NaCl (or KCl) and can then receive more hard water. The metal cations in the hard water react with the Na or K cations on the media, thereby causing the simultaneous release of the Na or K cations from the media and the retention of the Mg and Ca cations. Once the media are almost at capacity again, the unit must repeat the regeneration process. The final product is water with a small level of Na but no Ca or Mg cations, which causes it to be softened. Water with even small levels of sodium can have adverse effects on cooking, the taste of drinking water, and the efficacy of landscaping.

### BRIEF SUMMARY OF THE DISCLOSURE

In an embodiment, a treatment device for treating water with an electromagnetic field comprises a conduit, a transducer comprising a wire coil positioned around an outside of a portion of the conduit, and a controller electrically coupled to the transducer. The controller is configured to provide an alternating current to the transducer.

In an embodiment, a treatment device for treating water with an electromagnetic field comprises a conduit, a multi-section transducer comprising a plurality of wire coils positioned around an outside of a portion of the conduit, and a controller electrically coupled to the multi-section transducer. The plurality of wire coils are connected in series, the controller is configured to provide an alternating current to each wire coil of the plurality of wire coils.

In an embodiment, a method of treating water comprises passing inlet water through a conduit, subjecting the inlet water to a varying electromagnetic field within the conduit, changing at least one property of the inlet water within the conduit in response to the varying electromagnetic field, and producing a conditioned water. The method can also include passing an alternating electrical current through a transducer, and generating the varying electromagnetic field within the conduit in response to the passing the alternating electrical current through the transducer. The transducer comprises a wire coil disposed about at least a portion of the conduit.

These and other features will be more clearly understood from the following detailed description taken in conjunction with the accompanying drawings and claims.

Embodiments described herein comprise a combination of features and advantages intended to address various shortcomings associated with certain prior devices, systems, and methods. The foregoing has outlined rather broadly the features and technical advantages of the invention in order that the detailed description of the invention that follows may be better understood. The various characteristics described above, as well as other features, will be readily apparent to those skilled in the art upon reading the following detailed description, and by referring to the accompanying drawings. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 is a schematic view of an embodiment of a treatment device according to an embodiment;

FIG. 2 is a schematic view of another embodiment of a treatment device according to an embodiment;

FIG. 3 is a schematic view of still another embodiment of a treatment device used to heat the water during a treatment process according to an embodiment;

FIG. 4 is a schematic process flow diagram showing a recycle loop used according to an embodiment;

FIG. 5 schematically illustrates an embodiment of a turbulence inducing device for use with an embodiment of the treatment device;

FIGS. 6A-6C schematically illustrate different winding patterns for an embodiment of a transducer;

FIG. 7 schematically illustrates a controller that can be used with an embodiment of the treatment device; and

FIG. 8 is a schematic illustration of a high power, high throughput treatment device according to an embodiment.

### DETAILED DESCRIPTION OF THE PREFERRED EMBODIMENTS

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis.

Embodiments described herein relate to a method and a device for conditioning water. Specifically, an electric field is applied to water using a powerful current that flows through one or more coils wrapped around the pipe through which the water flows.

Disclosed herein are water conditioning systems and methods suitable for treating water having dissolved components such as minerals, carbon dioxide, and the like therein. The treatment of the water using an electromagnetic field may result in a portion of the components dissolved in the water to precipitate, thereby improving the overall properties of the water. The treatment of the water can use a transducer disposed externally to a conduit and an alternating electromagnetic field can be passed through the transducer. The varying electromagnetic field can result in an alternative electrical current and magnetic field flowing through the water in the conduit. In this configuration, the water acts as a conductor so that the system obeys Faraday's Law. Embodiments described herein have several advantages over past methods and devices for producing conditioned, or softened, water. For example, the instant invention can produce a stable product that can remain stable for over 18 months at a production rate of up to hundreds of gallons per minute. The process also does not add material to the water product, whether via metal ions from a direct contact conductor or sodium from an ion exchange water softener.

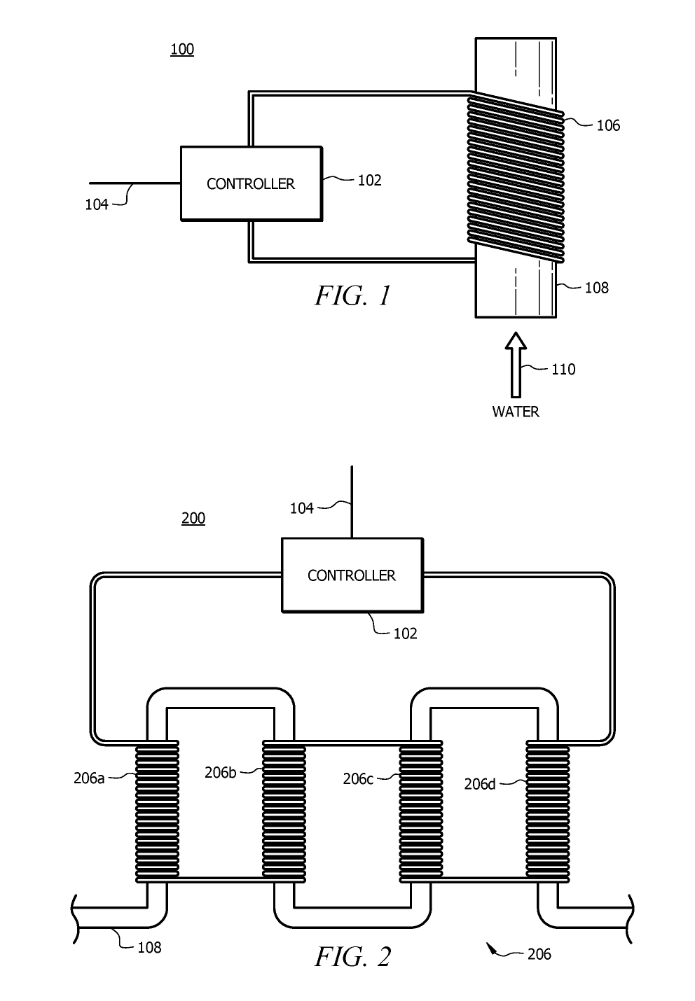

FIG. 1 schematically illustrates an embodiment of a water treatment apparatus according to an embodiment. As illustrated, the system 100 can comprise a controller 102 coupled to an electric inlet line 104. The controller 102 is electrically coupled to the transducer 106, which is wrapped around the conduit 108.

The controller 102 can provide an alternating current (AC) power source to a transducer 106 wrapped around a conduit 108. The current passing through the transducer 106 can generated an alternating electromagnetic field within the transducer 106, which is incident upon the water passing through the conduit 108. Specifically, the water is subject to the effects of the electromagnetic field generated within the transducer 106 as the water flow through the conduit 108 within the transducer 106.

In general, the conduit 108 serves to retain the water and support the transducer during use. The conduit 108 can have a circular cross section, though any cross-section can be used such as square, rectangular, oval, triangular, or the like. The length of the conduit 108 may be selected to provide a suitable distance to accommodate the length of the transducer 106. The conduit 108 may have one or more turns or bends, which may help provide a compact device while providing a suitable length for the transducer 106.

The conduit 108 can be made of any material suitable to contain the water and withstand electricity applied to it. For example, a plastic, such as PVC can be used to form the conduit 108. A plastic may be useful as it is both relatively inexpensive and electrically insulating. In some embodiments, a non-ferromagnetic material can be used to form the conduit 108. Suitable non-ferromagnetic materials can include, but are not limited to, copper, aluminum, non-ferromagnetic stainless steel, any alloy thereof, and any combination thereof.

During use, the transducer 106 can produce heat as a result of the current passing through the transducer 106. The selection of the material used for form the conduit 108 may be based on the desire to conduct the heat into the water. A metallic material such as copper, stainless steel, or aluminum can have a higher thermal conductivity than a plastic and therefore may be used when heat generation is an issue.

The diameter of the conduit 108 can vary based on the use of the device. For example, a larger diameter may be used when larger water throughputs are needed. In an embodiment, the diameter of the conduit 108 may be greater than about 0.1 inches, greater than about 0.25 inches, greater than about 0.5 inches, greater than about 0.75 inches, greater than about 1 inch, greater than about 1.5 inches, greater than about 2 inches, greater than about 3 inches, greater than about 4 inches, greater than about 5 inches, greater than about 6 inches, greater than about 10 inches, greater than about 12 inches, or greater than about 18 inches. In an embodiment, the diameter of the conduit 108 may be less than about 36 inches, less than about 30 inches, less than about 24 inches, less than about 20 inches, less than about 18 inches, less than about 16 inches, less than about 16 inches, less than about 14 inches, less than about 12 inches, less than about 10 inches, less than about 8 inches, or less than about 6 inches. The diameter of the conduit 108 may be selected between any of the lower diameter values and the upper diameter values.

In some embodiments, the conduit 108 can comprise an electrically insulating coating to reduce any electrically coupling between the transducer 106 and the conduit 108. The coating can comprise a polymeric or dielectric material that is non-magnetic (e.g., non-ferromagnetic). In an embodiment, the electrical coating can comprise a spray on coating such as a polyurethane or enamel coating. Other insulating materials such as a varnish (e.g. GE Glyptal, etc.) can also be used. If an electrical coating is present on the wire, the electrical coating on the conduit may not be present or may have a reduced thickness.

In an embodiment, the transducer 106 comprises a wire wound around a length of the conduit 108. Each end of the wire can be coupled to the controller 102 to receive the AC current. The length, both straight and coiled, and gauge of the wire are determined by the electric field required of the transducer that is necessary to alter the water that flows through the pipe. Different gauges of wire can be used to form the transducer 106. In general, the larger the diameter of the wire (e.g., the smaller the gauge), the larger the current that can flow through the wire without producing excess heat.

In general, the wire used for form the transducer 106 can be formed of any electrically conductive material. In an embodiment, the wire can be formed from copper, aluminum, steel, or any other suitable electrical conductor. The resistance of the material may be taken into account in determining the selection of the wire. Aluminum wire, which is commonly used in electrical trades today, has a higher resistance than copper, which can lead to more heat being developed for the same gauge of wire as compared to a copper wire.

In general, the length and gauge of the wire are selected to provide a desired resistance and therefore current through the transducer. The gauge of the wire may also affect the amount of heat generated, and a sufficient thickness can be selected to reduce the heat generation below a defined limit. The gauge and the length are interrelated to produce the desired resistance. Once the gauge is selected based on the throughput requirements, the length can be calculated to provide the desired resistance. The resulting length of the wire can then be wound around the conduit, which can determine the transducer 106 length.

The amount of the conduit 108 that is covered by the transducer 106 is not critical as long as the length of the conduit 108 covered is sufficient to provide a threshold residence time of the water in the electromagnetic field. This length may be based on the flow rate of the water and the strength of the electromagnetic field.

In an embodiment, the water velocity through the conduit 108 may affect the total time that the water is within the treatment zone. The water velocity may be low enough to allow the water to be treated and achieve a desired change in one or more of the water properties, as described in more detail herein. In an embodiment, the velocity of the water may be maintained below about 10 ft/s, below about 9 ft/s, below about 8 ft/s, below about 7 ft/s, below about 6 ft/s, or below about 5 ft/s. The water velocity can also be expressed as a flow rate for a given conduit diameter. For example, the water flow rate may be less than about 15 gallons per minute in a 1″ pipe (e.g., having a velocity below about 6 ft/s), below about 200 gallons per minute in a 4″ pipe (e.g., having a velocity below about 5 ft/s), or below about 600 gallons per minute in an 8″.

The use of the transducer may create an alternating electromagnetic field within the conduit 108. The components of the field strength are interrelated and can be measured separately. In an embodiment, a magnetic component of the field strength can be at least about 20 gauss, at least about 100 gauss, at least about 500 gauss, at least about 1000 gauss, or at least about 1200 gauss, where the magnetic field strength may be selected at least in part based on the alternating current frequency. For example, a 30 gauss field intensity may be effective at a frequency of about 2500 hertz, and a 1200 gauss field intensity may be effective at a frequency of 60 hertz. In an embodiment, the product of the field strength and frequency may be at least about 50,000 gauss-Hz, at least about 55,000 gauss-Hz, at about 60,000 gauss-Hz, at least about 65,000 gauss-Hz, at least about 70,000 gauss-Hz, or at least about 75,000 gauss-Hz.

The controller 102 serves to provide electrical power to the transducer 106 at a desired voltage, frequency, and waveform. The voltage supplied to the transducer 106 may vary depending on the specific application, and can be based on the expected flow rate of the water and/or the amount of change desired in the water. A voltage supply between about 12 V AC and about 480 V AC can be used. In an embodiment, the voltage applied to the transducer 106 may be between about 110 V AC and about 480 V AC.

The controller 102 may serve as a pass through of the electrical current received from the power source 104 to the transducer 106. In an embodiment, regular power line current corresponding to 120 V AC, 60 Hz power can be passed directly to the transducer 106. In some embodiments, 240 V AC, 60 Hz and/or 480 VAC, 60 Hz power can be supplied to the transducer, where the use of three-phase power supplies is described in more detail herein. As described in more detail herein, the controller 102 can comprise a transformer to provide a specified voltage output, a frequency generator to provide a desired frequency, and/or a waveform generator to produce a desired waveform (e.g., a square wave, sinusoidal wave, triangle wave, etc.) in some embodiments.

The voltage applied across the transducer 106 can be determined by the power source 104 and/or can be selected based on the voltage needed to produce the desired power throughput. The resulting combination of the applied voltage, wire gauge, and wire length may be used to calculate a current throughput. The various parameters can be varied to provide a desired electromagnetic field strength within water in the conduit 110.

In an embodiment, the frequency of the current applied to the transducer 106 may be varied to provide the alternating electromagnetic field. In an embodiment, the frequency of the electromagnetic current can vary between about 10 Hz and about 200 kHz, or between about 50 Hz and about 30 kHz. Alternating current frequencies between about 60 Hz and 30 kHz were tested. Since the results did not change significantly, a frequency of about 60 Hz may be used in some embodiments based on simplicity. In an embodiment, the frequency may be substantially constant during use.

The frequency of the alternating electromagnetic current applied to the transducer 106 can be maintained at a constant frequency during the treatment process or it can be varied. When the frequency is varied, the frequency can range between about 10 Hz and about 200 kHz over a time period of about 0.5 seconds to about 30 seconds. The frequency can rise and then fall in a steady pattern, rise and then reset to the lower value, or vary over any other suitable pattern. In an embodiment, the frequency can rise from about 30 Hz to about 30 kHz over a period between about 1 second and 10 seconds and then fall back to 30 Hz over a similar time period.

The power level applied to the transducer 106 affects the amount of change in the final product. In an embodiment, as the amount of power applied to the transducer 106 increases, so does the change in the parameters of the product water. The transducer 106 may be capable of accepting a power level ranging from about 1 watt to about 10 kilowatt. The amount of power applied to the transducer 106 can be varied based on the treatment application including the number of anticipated passes through the device 100, the water flowrate, and the like. For example, an agricultural or landscape application may require about 500 watts. A larger scale application could require several kilowatts or more.

In general, the treatment device 100 can be used to treat any fluid comprising ions, salts, polar molecules or the like that can be affected by the varying electromagnetic field. The fluid can comprise an aqueous fluid that comprises water and one or more dissolved compounds. In an embodiment, the aqueous fluid comprises water and dissolved minerals and gases of the type generally found in water supplies. While the aqueous fluid contains more than just water, the fluid can be referred to herein as “water” for purposes of this application.

The electric current applied to the transducer 106 results in an applied electromagnetic field in the water 110 that can alter the oxidation reduction potential (ORP), the total dissolved solids (TDS), the pH, the water hardness, and the electric conductivity (EC) of the water. Generally, properties of water, such as physical and/or chemical properties, are defined by composition and/or molecular interactions between any components present in water. For purposes of the disclosure herein, the water that is subjected to a method of water treatment as disclosed herein will be referred to as “water,” and the water obtained as a result of a method of water treatment as disclosed herein will be referred to as “conditioned water.” Further, for purposes of the disclosure herein, the terms “treat,” condition,” “soften,” “convert,” and “process,” when used to describe a method of water treatment as disclosed herein, can be used interchangeably, and refer to the process of producing conditioned water from water.

In an embodiment, the water can comprise any suitable water source. Nonlimiting examples of water suitable for producing conditioned water as disclosed herein include fresh water, ground water, tap water, potable water, non-potable water, well water, waste water, recycled water, reclaimed water, greywater, irrigation water, industrial water, fracking water, and the like, or combinations thereof. As will be appreciated by one of skill in the art, and with the help of this disclosure, the water can have a different composition, depending on the source. The water used with the system 100 contains water molecules and various dissolved solids and/or ions. In general, the use of pure water without any dissolved ions may not interact with the produced electromagnetic field to exhibit any change in the properties of the water. Water can generally comprise water molecules (e.g., undissociated water molecules), water molecules dissociated into hydronium ions (H₃O⁺) and hydroxyl ions (HO⁻), dissolved solids, dissolved minerals, dissolved ions, dissolved cations (e.g., Ca²⁺, Mg²⁺, Na⁺, K⁺, Fe²⁺, etc.), dissolved anions (e.g., Cl⁻, HCO₃⁻, CO₃²⁻, SO₄²⁻, etc.), dissolved gases (e.g., O₂, CO₂, H₂CO₃, etc.), and the like.

Generally, most properties that are unique to water (as opposed to other solvents), such as density, boiling point, melting point, etc., arise from the presence of hydrogen bonding between water molecules. As will be appreciated by one of skill in the art, and with the help of this disclosure, liquid water contains one of the densest hydrogen bondings of any solvent, having almost as many hydrogen bonds as there are covalent bonds. Without wishing to be limited by theory, water molecules (e.g., undissociated water molecules) can form a cluster with a tetrahedral structure (e.g., water molecules can cluster in groups) comprising five or more water molecules, wherein a water molecule can be located in the center of the tetrahedral structure (e.g., tetrahedron), surrounded by and hydrogen bonded to four other water molecules located in the corners of the tetrahedral structure. Further, as will be appreciated by one of skill in the art, and with the help of this disclosure, hydrogen boding in water can rapidly rearrange in response to changing conditions and environments, such as for example solutes (e.g., dissolved solids, dissolved minerals, dissolved ions, dissolved cations, dissolved anions, dissolved gases, etc.).

For example, carbon dioxide (CO₂) is soluble in water, although it doesn't have a dipole moment and it is a rather large molecule when compared to the water molecule, and such solubility can be attributed in part to hydrogen bonding between the oxygen atoms in CO₂ and water molecules. Atmospheric CO₂ (wherein CO₂ is in gas (g) phase) can dissolve in water (wherein CO₂ is in aqueous (aq) phase), as represented by equation (1):

CO_{2(g)}+H₂O [symbol] CO_{2(aq)} (1)

As will be appreciated by one of ordinary skill in the art, and with the help of this disclosure, the equilibrium depicted in equation (1) can be shifted in either direction based on temperature, pressure, composition of water, etc. For example, if the CO_{2(aq)} is used in a reaction in water (such as depicted by equation (2), for example), then the equilibrium depicted in equation (1) can shift to the right, and more CO_{2(aq)} can be solvated and enter the aqueous phase, becoming CO_{2(aq)}. Further, as will be appreciated by one of ordinary skill in the art, and with the help of this disclosure, gases have a higher solubility in water at lower temperatures, and increasing the temperature of water can shift the equilibrium depicted in equation (1) to the left, by causing the CO₂ to exit the water into the gas phase (e.g., air, atmosphere, etc.). CO_{2(aq)} can react with water to form carbonic acid (H₂CO₃) according to equation (2):

CO_{2(aq)}+H₂O [symbol] H₂CO₃ (2)

H₂CO₃ is soluble in water and it forms hydrogen bonds with water molecules both through its hydrogen atoms and its oxygen atoms. H₂CO₃ ionizes in water in two steps, by forming the bicarbonate anion (HCO₃⁻) according to equation (3) in a first step, and the carbonate anion (CO₃²⁻) according to equation (4) in a second step:

H₂CO₃+H₂O [symbol] H₃O⁺+HCO₃⁻ (3)

HCO₃⁻+H₂O [symbol] H₃O⁺+CO₃²⁻ (4)

Dissolution of CO₂ in water decreases the pH (e.g., increases the acidity) of the water by generating hydronium ions (H₃O⁺) according to equations (3) and (4). Without wishing to be limited by theory, H₃O⁺ can be positioned in the middle of a water cluster comprising 20 water molecules (e.g., dodecahedron), forming a “magic number cluster” H₃O⁺(H₂O)₂₀, wherein H₃O⁺ forms hydrogen bonds with the surrounding water molecules, and wherein such surrounding water molecules form hydrogen bonds with each other.

Generally, dissolved cations have more than one hydration shell, such as a primary hydration shell, a secondary hydration shell, a tertiary hydration shell, etc. A hydration shell or hydration sphere is a special case of a solvation shell, wherein the solvent is water, and it refers to the arrangement of water molecules surrounding an ion (e.g., cation) in an aqueous solution (e.g., water). Generally, water molecules form a sphere (e.g., hydration shell or hydration sphere) around a metal ion. The electronegative oxygen atom of the water molecules of the hydration shell is attracted electrostatically to the positive charge of the metal ion, thereby resulting is a solvation shell of water molecules that surround the metal ion. The hydration shell can be several water molecules thick (e.g., primary hydration shell, a secondary hydration shell, a tertiary hydration shell, etc.), depending upon the charge of the metal ion. As will be appreciated by one of ordinary skill in the art, and with the help of this disclosure, the larger the charge of the metal ion, the more water molecules will be present in the hydration shell of that particular metal ion. Water clustering (e.g., hydration shell formation) around cations (e.g., Ca²⁺, Mg²⁺, Na⁺, K⁺, Fe²⁺, as well as cations of trace elements, etc.) allows for the retention of such cations in water (e.g., aqueous solution). Without wishing to be limited by theory, a calcium cation (Ca²⁺) has at least six water molecules in a first hydration shell, and at least about 9-10 water molecules in a second hydration shell. Further, without wishing to be limited by theory, the water molecules in the first hydration shell can be attracted electrostatically to Ca²⁻, due to their dipole moment, and can coordinate directly to Ca²⁺, while the water molecules in the second hydration shell are hydrogen bonded to the water molecules of the first hydration shell. Similarly, a magnesium cation (Mg²⁻) has six water molecules in a first hydration shell, and twelve water molecules in a second hydration shell. The water molecules in the first hydration shell can be attracted electrostatically to Mg²⁺, due to their dipole moment, and can coordinate directly to Mg²⁺, while the water molecules in the second hydration shell are hydrogen bonded to the water molecules of the first hydration shell.

This chemistry can help to explain the interactions between the electromagnetic field produced by the transducer 106 and the water in the conduit 108. In an embodiment, water can comprise water clusters, wherein the water clusters can form around and stabilize solutes (e.g., dissolved solids, dissolved minerals, dissolved ions, dissolved cations, dissolved anions, dissolved gases, etc.). The water clusters of the water can be characterized by an average water cluster size. Generally, the average water cluster size refers to an average size of the water clusters present in the water, wherein the water clusters are present due to H₃O⁺ (e.g., magic number clusters H₃O⁺(H₂O)₂₀), dissolved or solvated cations (e.g., Ca²⁺, Mg²⁺, Na⁺, K⁺, Fe², etc.) clusters, etc.

In an embodiment, the water can be characterized by a water pH. Generally, the pH of water (or aqueous solution) is a measure of the hydrogen ion content of the water. The lower the pH value, the more acidic the water (or aqueous solution); and the higher the pH, the more basic the water (or aqueous solution). In some embodiments, the water entering the system can be characterized by a lower pH of from about 7.0 to an upper pH of about 8.2, of about 8.0, or about 7.8, or about 7.6, or about 7.4, or of about 7.2. Thus, the inlet water can have a range between about 7.0 and any of the upper pH values.

In an embodiment, the water can be characterized by a water total dissolved solids (TDS). Generally, TDS is a measure of a combined content of mobile charged ions, including minerals, salts or metals dissolved in a given volume of water, and can be expressed in units of mass (mg) per unit volume of water (mg/L), which can also be referred to as parts per million (ppm). TDS can comprise inorganic salts (e.g., calcium, magnesium, potassium, sodium, bicarbonates, carbonates, chlorides, sulfates, etc.). TDS in water can originate from natural sources (e.g., natural environmental features such as mineral springs, carbonate deposits, salt deposits, sea water intrusion, etc.), sewage, urban run-off, industrial wastewater, chemicals used in water treatment processes, the nature of piping or hardware used to convey the water (e.g., plumbing), and the like, or combinations thereof. In some embodiments, the water can be characterized by a water TDS of greater than about 280 mg/L, greater than about 300 mg/L, greater than about 400, greater than about 500 mg/L, greater than about 600 mg/L, or greater than about 700 mg/L. In some embodiments, the upper limit on the TDS content may be at or near saturation, which can depend on the specific composition of the compound or compounds dissolved in the water and the temperature and pressure of the water. In some embodiments, the water can be characterized by a water TDS of less than about 1800 mg/L, less than about 1500 mg/L, less than about 1200 mg/L, less than about 1000 mg/L, less than about 800 mg/L, or less than about 700 mg/L. The water TDS can vary between any of the lower values to any of the upper values.

In an embodiment, the water can be characterized by a water hardness. Generally, hardness is a measure of a dissolved multivalent cations (i.e., with a charge of equal to or greater than 2) in a given volume of water, and can be expressed in mg/L or ppm. Water hardness can also be commonly expressed in grains of hardness, wherein 1 grain of hardness=17.1 mg/L. The primary contributors to water hardness are calcium ions (Ca²⁺) and magnesium ions (Mg²⁺); however, other cations, such as for example ferrous ions (Fe²⁺) and manganese ions (Mn²⁺), can also contribute to water hardness, based on their concentration and/or presence in the water. In some embodiments, the water can be characterized by a water hardness greater than about 200 mg/L, greater than about 250 mg/L, greater than about 300 mg/L, greater than about 350 mg/L, or greater than about 400 mg/L. In some embodiments, the water can be characterized by a water hardness of less than about 1800 mg/L, less than about 1500 mg/L, less than about 1200 mg/L, or less than about 1000 mg/L. The hardness of the water can vary between any of the lower values to any of the upper values.

In an embodiment, the water can be characterized by a water oxidation reduction potential (ORP). Generally, ORP is a measure of water's ability to either release or accept electrons from chemical reactions, and it is commonly expressed in mV vs. a reference electrode (e.g., Ag/AgCl in 3M KCl, standard hydrogen electrode (SHE), etc.). The ORP can change with the introduction of a chemical species into the water, which chemical species can be the same as or different from the species already present in the water. The ORP can also change with the removal of at least a portion of a chemical species (e.g., Ca²⁺) from water. In some embodiments, the water can be characterized by a water ORP at 25° C. of greater than about 300 mV, greater than about 350 mV, greater than about 400 mV, greater than about 450 mV, greater than about 500 mV. In some embodiments, the water can be characterized by a water ORP at 25° C. of less than about 700 mV, less than about 650 mV, less than about 600 mV, less than about 550 mV, or less than about 500 mV. The ORP of the water can vary between any of the lower values to any of the upper values.

In an embodiment, the water can be characterized by a water electrical conductivity. Generally, electrical conductivity is a measure of water's ability to pass an electrical current, and can be expressed in micro-Ohms per centimeter (μmhos/cm) or microsiemens per centimeter (μS/cm). The electrical conductivity in water can be affected by the presence of inorganic dissolved solids such as dissolved cations, dissolved anions, etc., and by temperature (i.e., the warmer the water, the higher the electrical conductivity). In some embodiments, the water can be characterized by a water electrical conductivity at 25° C. of greater than about 500 μS/cm, greater than about 1000 82 S/cm, greater than about 2000 μS/cm, greater than about 3000 μS/cm, greater than about 4000 μS/cm, or greater than about 5000 μS/cm. In some embodiments, the water can be characterized by a water electrical conductivity at 25° C. of less than about 7000 μS/cm, less than about 6000 μS/cm, less than about 5000 μS/cm, less than about 4000 μS/cm, less than about 3000 μS/cm, less than about 2000 μS/cm, or less than about 1000 μS/cm. The electrical conductivity of the water can vary between any of the lower values to any of the upper values.

In an embodiment, the water can be characterized by a water surface tension. Generally, surface tension is a result of cohesive forces between water molecules, and is a measure of how well the water surface can resist an external force, due to interactions between water molecules. Surface tension is dependent upon the amount of dissolved ions in the water (e.g., an increased water salt content leads to an increased surface tension) as well as temperature. Surface tension, adhesion and cohesion of water are important in defining a capillary action for water, which in turn is important in agriculture (e.g., water absorption in plants). Generally, capillary action or capillarity, is the ability of water to flow in narrow spaces (e.g., pores, capillaries, etc.) without the assistance of, and in opposition to, external forces such as gravity. Capillary action occurs when adhesion of water to the narrow spaces is stronger than the cohesive forces between the water molecules, is limited by surface tension (e.g., the greater the cohesion, the greater the surface tension, the lower the capillary action) and gravity. Surface tension can be measured for water against air, and can be expressed in mN/m or dyn/cm. In general, the surface tension tends to increase in a nearly linear fashion as the TDS content of the water increases.

In an embodiment, the conditioned water can be produced after the water is subjected to an electromagnetic field. Without wishing to be limited by theory, the electromagnetic field can cause the water molecule dipoles to orient based on the parameters of the field, thereby disrupting the water clusters (e.g., calcium hydration shells, which are water clusters formed around Ca²⁺) by energizing the hydrogen bonds to a higher energy potential and making ions more available for reactions. One such reaction can be the formation of a calcium carbonate (CaCO₃) solid (s) from Ca²⁺ and CO₃²⁻ as represented by equation (5):

Ca²⁺+CO₃²⁻ [symbol] CaCO₃₍ₛ₎ (5)

CaCO₃ is a solid that does not exhibit a charge when precipitated from the water. Further, other compounds could precipitate in similar manner, due to the ions becoming more available to react, such as for example magnesium hydroxide, calcium sulfate, barium sulfate, calcium phosphate, zinc phosphate, iron hydroxides, and the like, or combinations thereof. Removal of ions from solution by forming insoluble solids (e.g., precipitates) can cause the average cluster size to be reduced, due to a decrease in the number of solvated ions. In an embodiment, the conditioned water can be characterized by an average conditioned water cluster size that is less than the average water cluster size. Generally, the average conditioned water cluster size refers to an average size of conditioned water clusters present in the conditioned water, wherein the conditioned water clusters are present due to H₃O⁺(e.g., magic number clusters H₃O⁺(H₂O)₂₀), dissolved or solvated cations (e.g., Ca²⁺, Mg²⁺, Na⁺, K⁺, Fe², etc.) clusters, etc. When the number of water clusters formed around solvated ions is decreased, the much smaller tetrahedral structures of water molecules can have a larger impact and reduce the average size of conditioned water clusters. The conditioned water can be referred to as “skinnier” than the water, which means that the conditioned water could pass through capillaries in plants and structured soil more easily and better than water, because some of the water molecules are no longer clumped (e.g., clustered) together in hydration shells around solvated ions. CaCO₃ and any other precipitated compounds (e.g., magnesium hydroxide, calcium sulfate, barium sulfate, calcium phosphate, zinc phosphate, iron hydroxides, etc.) could form limescale, and as such their removal from water to produce conditioned water can be advantageous. For example, the formation of a precipitate as a solid in particulate form may be more easily removed from the water as compared to the formation of scale on the walls of pipes and other equipment.

In an embodiment, the conditioned water pH can be increased when compared to the water pH by equal to or greater than about 0.1 pH units, alternatively by equal to or greater than about 0.2 pH units, alternatively by equal to or greater than about 0.3 pH units, alternatively by equal to or greater than about 0.4 pH units, alternatively by equal to or greater than about 0.5 pH units, alternatively by equal to or greater than about 1 pH unit, alternatively by equal to or greater than about 1.5 pH units, alternatively by equal to or greater than about 2.0 pH units, alternatively by equal to or greater than about 2.5 pH units, or alternatively by equal to or greater than about 3.0 pH units.

In an embodiment, the conditioned water TDS can be decreased when compared to the water TDS by at least about 10%, at least about 20%, at least about 30%, at least about 40%, or at least about 50%.

In an embodiment, the conditioned water hardness can be decreased when compared to the water hardness by at least about 20%, at least about 30%, at least about 40%, at least about 50%, or at least about 60%.

In an embodiment, the conditioned water ORP can be decreased when compared to the water ORP by equal to or greater than about 20 mV, alternatively equal to or greater than about 30 mV, alternatively equal to or greater than about 40 mV, or alternatively equal to or greater than about 50 mV.

In an embodiment, the conditioned water electrical conductivity can be decreased when compared to the water electrical conductivity by at least about 10%, at least about 20%, at least about 30%, or at least about 40%.

In an embodiment, the conditioned water surface tension can be decreased when compared to the water surface tension by at least about 10%, at least about 20%, at least about 30%, or at least about 40%

In an embodiment, the conditioned water can be stored for a period of time while maintaining the conditioned water properties. While the conditioned water is stored, the CaCO₃ and any other precipitated compounds (e.g., magnesium hydroxide, calcium sulfate, barium sulfate, calcium phosphate, zinc phosphate, iron hydroxides, etc.) could settle to the bottom of the storage container to form a settled precipitate. The conditioned water can be removed from (e.g., decanted) the storage container containing the settled precipitate and can be further used for any suitable purpose. The storage container comprising the stored conditioned water can be sealed from the outer environment, thereby preventing the diffusion of CO_{2(g)} back into water according to equation (1). In an embodiment, the conditioned water can be characterized by a stability of equal to or greater than about 1 year, alternatively equal to or greater than about 2 years. Generally, the stability of conditioned water refers to the ability of conditioned water to retain its changed properties (e.g., pH, TDS, hardness, ORP, electrical conductivity, surface tension, etc.) over time.

While discussed in terms of water, the treatment device can also be used to treat other fluids. For example, fluid containing water and hydrocarbon fluids can be treated to cause a separation of the fluid. The treatment device can also be used to provide the activation energy for certain chemical reactions. For example, chemical production using polar or ionic liquids can be passed through the treatment device, and the transducer can be used to provide an activation energy for the reaction. While not intending to be limited by theory, the resulting intermediate products may serve as a catalyst for further reactions and/or as initiation sites for the precipitation of one or more components (e.g., such as some of the reaction products). As a result, water may not be the only fluid suitable for use with the treatment device 100.

In use, the system 100 can be used to treat water 110 flowing through the conduit 108. In an embodiment, the water 110 can be passed through the conduit 108. The water 110 can be subjected to an electromagnetic field as the water 110 passes through the conduit 108 within the transducer 106 to produce conditioned water, wherein the electromagnetic field can be generated by the transducer 106 positioned around the pipe. The water can be characterized by various criteria including a water pH, an oxidation reduction potential (ORP), a total dissolved solids (TDS), a water hardness, and an electric conductivity (EC). The conditioned water can then be recovered from the conduit 108 for a variety of downstream uses and/or recycled back to the conduit 108 for a multi-pass treatment. The conditioned water can be characterized by the same criteria, and the criteria can change in the conditioned water as a result of the treatment. In an embodiment, the conditioned water pH can increase (e.g., become more basic) by at least about 0.1 pH units, and the conditioned water hardness can be reduced by equal to or greater than about 20%, when compared to the water hardness. A precipitant may also be formed as a result of the treatment as described above.

Another embodiment of a treatment device 200 is schematically illustrated in FIG. 2. As shown in FIG. 2, a conduit 108 can have a transducer 206 disposed about the conduit 108, and the transducer 206 can be coupled to the controller 102. The controller 102 and the conduit 108 can be the same or similar to the controller 102 and conduit 108 described with respect to FIG. 1.

As shown, the transducer 206 can be separated into a plurality of sections 206a, 206b, 206c, 206d. In this embodiment, the transducer 206 is separated into four sections 206a, 206b, 206c, 206d, though two, three, or five or more sections can also be used. In an embodiment, a multi-section transducer 206 can have between about 2 and 50 sections. The beginning of the wire in the first section 206a is coupled to the controller 102. Each section of the transducer is connected in series with the end of the wire coil in the first section 206a connected to the beginning of the second section 206b of the wire coil. Similarly, the third section 206c and the fourth section 206d are also arranged in series. The end of the wire in the fourth section 206d is coupled to the controller 102. Each section 206a, 206b, 206c, 206d of the transducer 206 serves to provide a portion of the electromagnetic field within the conduit 108.

The length of the transducer sections 206a, 206b, 206c, 206d can be approximately the same or they can be different. In an embodiment, the approximate lengths of the transducer sections 206a, 206b, 206c, 206d can be approximately the same and may be configured to deliver an corresponding portion of the electromagnetic field to the water in the conduit 108. For example, when four sections 206a, 206b, 206c, 206d are present, each section may provide approximately one fourth of the overall electromagnetic field to the water. This may also be expressed by noting that each section 206a, 206b, 206c, 206d may experience a corresponding portion of the voltage drop. For example, when the voltage applied across the transducer 206 is approximately 120 V AC, each section 206a, 206b, 206c, 206d may be designed to have an approximately 30 V drop. When multiple sections are arranged in series, each section may be configured to have a voltage drop between about 20 V and 80 V, or between about 30 V and about 60 V.

As described in more detail below, a turbulence inducing structure may be used to improve the mixing of the water within the conduit 108 while the water is within the transducer 206 sections. The mixing may improve the interaction of the reactive species within the water to aid in the overall reactions to produce the conditioned water. The use of a multi-section treatment device having one or more turns or bends in the conduit 108 may aid in providing a turbulent flow regime to increase the mixing in the water through the treatment device 200.

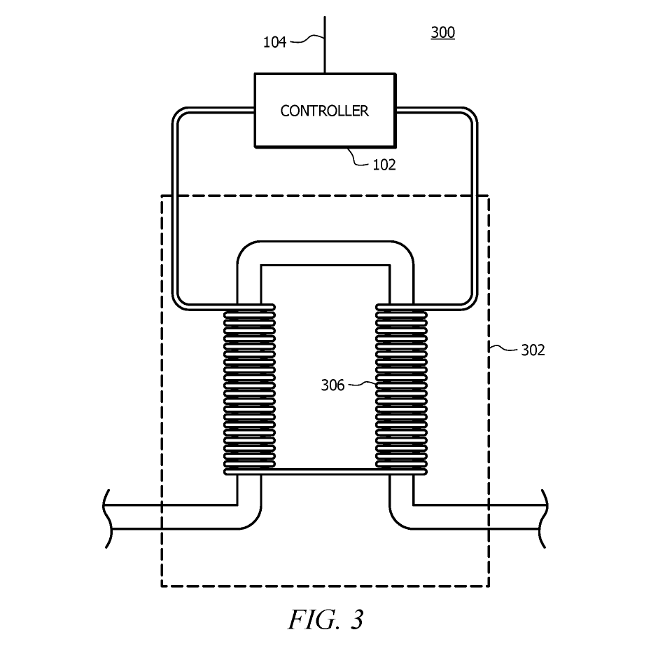

Another embodiment of a treatment device is shown in FIG. 3. In this embodiment, the water may be heated by the transducer 306 in addition to be treated by the electromagnetic field as the water passes through the device 300. As in the prior embodiments, the controller 102 and the conduit 108 may be the same or similar to the controller 102 and conduit 108 described with respect to FIG. 1. In this embodiment, the transducer 306 may be configured to produce excess heat, and the transducer 306 and conduit 108 may be contained within an insulated enclosure 302 schematically illustrated by the dashed line in FIG. 3.

In this embodiment, the transducer 306 can be designed to produce excess heat that can be transferred into the water to heat the water. In order to produce the heat, the wire size and/or material used to form the transducer 306 can be selected to produce excess heat when the current is passed through the transducer 206. For example, the size of the wire can be selected to be smaller than a comparative wire. The reduced size may have a higher resistance per unit length, which may generate heat during use. Similarly, a material having an increased resistance can be selected to form the wire, and thereby produce more heat for heating the water.

When the transducer 306 is configured to produce excess heat to heat the water, the conduit 108 may be formed from a material having a relatively high thermal conductivity. For example, the conduit 108 may be formed from copper, aluminum, non-magnetic stainless steel, or the like in order to efficiently transfer the heat produced by the transducer 306 into the water. The enclosure 302 can comprise insulation disposed between the enclosure and the transducer 306. The enclosure 302 and the insulation may retain the heat within the enclosure 302 and aid in providing a temperature differential to increase the heat transfer potential into the water in the conduit 108.

While the transducer 306 illustrated in FIG. 3 contains two sections, any suitable number of sections can be used in series and/or parallel to produce the desired temperature increase. In an embodiment, the use of the system 300 can provide increase in the temperature of the water by equal to or greater than about 5° C., alternatively by equal to or greater than about 10° C., alternatively by equal to or greater than about 15° C., alternatively by equal to or greater than about 20° C., alternatively by equal to or greater than about 30° C., or alternatively by equal to or greater than about 40° C. As will be appreciated by one of skill in the art, and with the help of this disclosure, increasing the temperature of the water will cause CO_{2(g)} to leave the water, thereby shifting to the left the equilibrium in equations (1), (2), (3), and (4), and causing an increase in pH. Without wishing to be limited by theory, an increase in pH will cause more CaCO₃ and magnesium hydroxide precipitation, as well as a decrease in the number of magic number clusters H₃O⁺(H₂O)₂₀ (owing to a decrease in hydronium ions by shifting to the left the equilibrium in equations (3) and (4)), thereby further reducing the average size of conditioned water clusters. Further, an increase in the temperature of water will cause calcium bicarbonate to produce CaCO₃₍ₛ₎ and CO_{2(g)} according to equation (6):

Ca(HCO₃)_{2(q)}→CO_{2(g)}+H₂O+CaCO₃₍ₛ₎ (6)

This may produce an increased effect in the conditioned water by removing a portion of the bicarbonate ion as a carbonate precipitate.

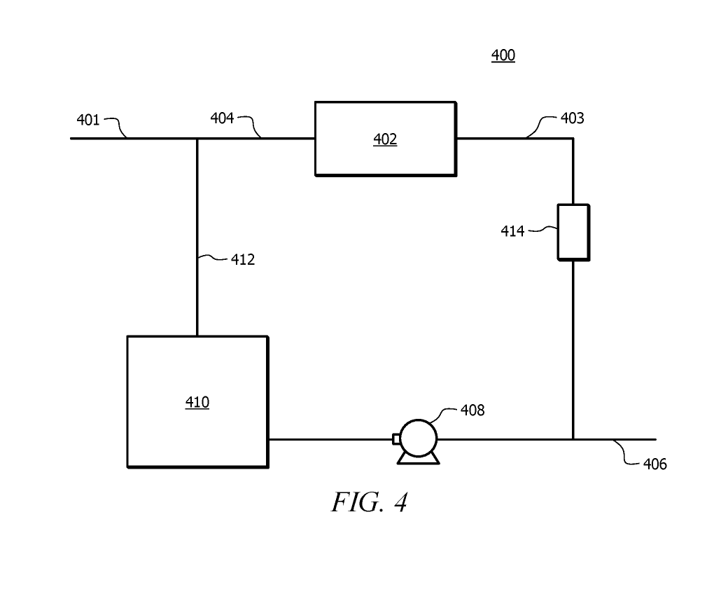

Increased time within the treatment zone may produce additional benefits in some embodiments. In order to increase the exposure time of the water to the electromagnetic field, a system having a recycle line can be used to pass the water through the treatment zone two or more times. FIG. 4 schematically illustrates an embodiment of the system 400 having a recycle line 412 in the system 400. As illustrated, the inlet line 401 can pass untreated water into the system 400. The inlet line 401 can combine water with water in the recycle line 412 to form a combined stream 404, which can pass into the treatment zone 402. The treatment zone 402 can comprise any of the embodiments of the treatment system described herein (e.g., treatment system 100, treatment system 200, treatment system 300, etc.). Once treated in the treatment system 402, the conditioned water can pass to an outline line 403, which can be split into a conditioned water outlet line 406 and the recycle line 412. A motive device 408 such as a pump or the like can be used to circulate the water within the recycle line 412.

An optional storage tank 410 can be placed at any location within the recycle line 412. The storage tank 410 may serve to provide a large fluid capacity within the recycle system as well as providing a settling tank for removing any solid precipitate that may form as a result of the water treatment. In an embodiment, the motive device 408 can be placed upstream or downstream of the storage tank 410.

In some embodiments, one or more inline sensors can be placed within the recycle loop. For example, one or more sensors can be placed in a sensor package 414 in the outlet line 403 to detect the properties of the conditioned water passing through the treatment system 402. The sensors in the sensor package 414 can detect any of the properties described herein. In some embodiments, the sensor can include a pH meter, a TDS meter, an ORP sensor, or the like. While illustrated as a single sensor package 414, a plurality of sensor packages could be disposed in series. Further, the sensors can be placed at any point in the recycle loop including within the optional storage tank 410. The sensors can then be used during the operation of the system to determine the properties of the conditioned water.

The system 400 having the recycle line 412 can be operated in a continuous, batch, or semi-batch operation mode. In a continuous operation system, the water supplied through the inlet line 401 can be continuously introduced and combined with the conditioned water in the recycle line 412. The ratio of the inlet water to the recycle water can range from about 1:1000 to about 1000:1 on a volumetric basis, depending on the amount of treatment desired in the conditioned water. The water passing through the conditioned water outline line 406 may have a flowrate that is approximately the same as the flowrate into the system 400 through the inlet line 401. The relative flowrates of the water in the inlet line 401 and the water passing through the recycle line 412 can determine the approximate number of times that the water is recycled through the treatment zone 402. In an embodiment, the water can be effectively recycled through the treatment zone 402 between about 2 and about 50 times. The number of times the water is recycled may depend, at least in part, on a measurement of a desired water property (e.g., using the sensors in the sensor package 414) where the water can be recycled until the water property is achieved.

In a batch operation mode, the system 400 can be charged with water to be treated through inlet line 401. Once filled, inlet line can be closed, and the water in the recycle line can be circulated until the desired treatment amount is supplied to the water. In this embodiment, the water can be recycled through the treatment zone 402 between about 2 and about 50 times. For example a target conditioned water property can be monitored to determine when the water reaches the target level. Once the water is conditioned, the water can be removed from the system 400 through the conditioned water outlet line 406.

The system 400 may also operate under a semi-batch operating mode. In this embodiment, the system 400 can be charged with water to be treated. Periodically or at certain intervals, a portion of the water in the system 400 can be taken out of the recycle line 412 through the conditioned water outlet line 406 and the water can be refilled through the inlet line 401.

The use of the system 400 having the recycle line may be useful in producing conditioned water with the desired outlet properties. The system 400 may also be useful when the treatment zone 402 has a smaller volume or field strength than needed to produce the desired conditioned water parameters. Thus, the ability to recycle the water may allow the system 400 to produce conditioned water with the same properties as a larger unit with a stronger electromagnetic field, which may allow the system to be smaller while achieving the same results.

Running the water through the device more than one pass increases the pH, the OPR, and the hardness, but the number of passes required and the changes affected must be balanced with the ultimate use of the water and the required parameters. If water is pumped through a transducer about 30 times, the pH of the water is increased from 7.5 to above 8.5 or even 9. A pH as high as 9.2 has been achieved. It is thought that alkaline water has potential health benefits and improved taste. Furthermore, for hydroponic applications, the more passes the water goes through, the better.

Various additional structures may be used within the conduit 108 in any of the embodiments disclosed herein in order to increase mixing of the water while the water is in the treatment zone. As the water passes through the treatment zone, the use of a turbulence inducing structure may improve the treatment of the water. Various structures including an internal mixing structure such as a helix, a piping configuration having one or more bends, or any other structure or feature to induce turbulence can be used.

In an embodiment, the use of a multi-section transducer may be used to induce turbulence. For example, the embodiment illustrated in FIG. 2 may be used where the conduit 108 has multiple sections connected by bends in the conduit 108. The use of multi-section transducer 206 that is connected in a series has the added advantage of causing more turbulence in the water flow due to the bends in the connector pieces that cause the water to change directions. The increased turbulence due to the bends may cause the water to mix within the conduit 108 and be subjected to the electromagnetic field substantially equally and uniformly such that all of the water is treated by the strongest part of the field near the outer edge of the inner diameter of the pipe. The increased turbulence may also increase the interaction between the reactive components in the water, thereby improving the overall treatment efficiency of the water.

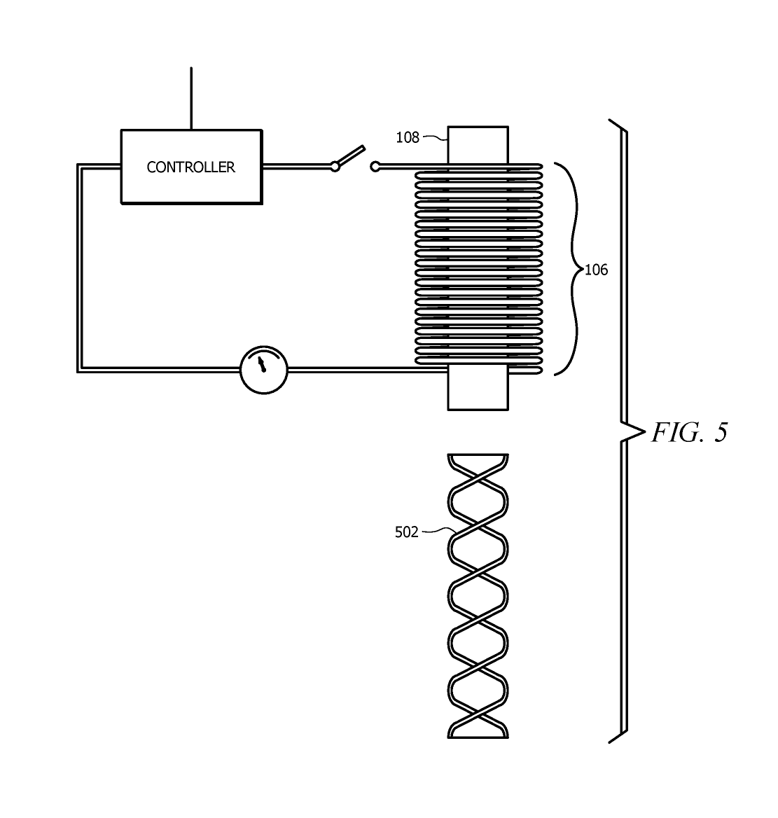

In some embodiments, a structure can be placed within the conduit to induce turbulence. FIG. 5 illustrates an insert 502 that can be placed within the conduit 108. The insert 502 can include a number of shapes. As shown in FIG. 5, the insert 502 can be in the shape of a helix. The helix can be twisted about a central axis to direct the water in a helical pattern through the coil in the treatment zone. The helical pathway may also slow down the axial flow of the water to increase the exposure of the water to the electromagnetic radiation. The outside diameter of the helix or thread can be approximately the same as the inside diameter of the pipe so that an interference fit is formed between the insert 502 and the conduit 108. The length of the insert 502 depends on the desired results of the conditioned water and can be approximately the same length as the transducer or a transducer section. In some embodiments, the length of the insert 502 can be shorter or longer than the length of the transducer or a transducer section.

While described as a helix, additional inserts may similarly create turbulence within the conduit 108. In an embodiment, the insert 502 can comprise a series of cross-structures such as pins, wires or the like. In some embodiments, the insert 502 can comprise a mesh or gauze, which may create a tortuous pathway through the material to create turbulence and an increased path length. Other inserts may also be suitable.

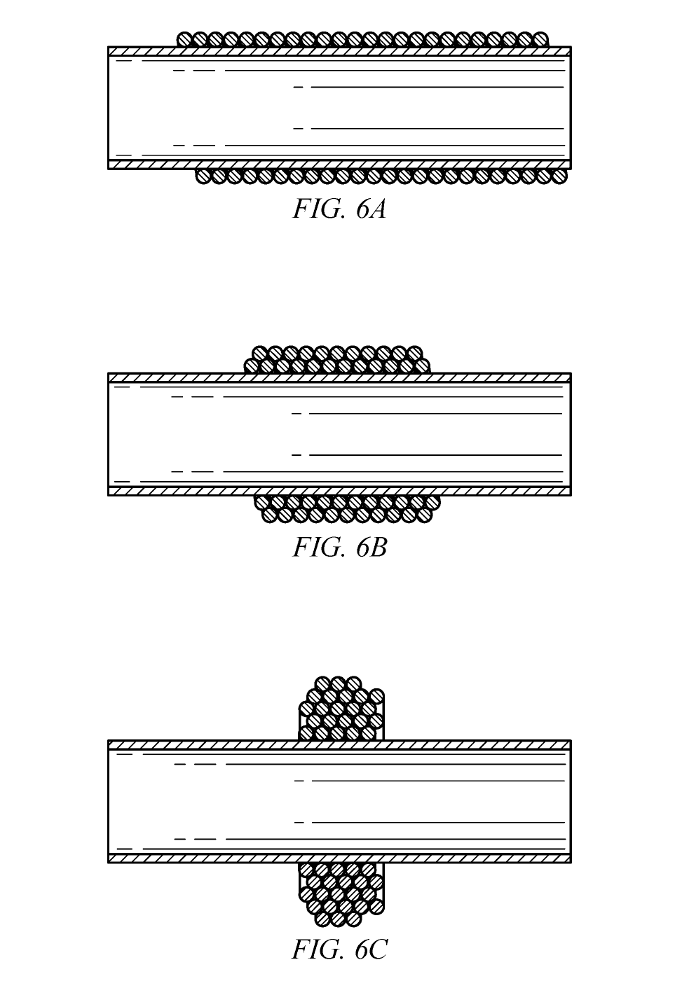

The winding pattern of any of the transducers (e.g., transducer 106, transducer 206, transducer 306, etc.) described herein can have a single layer configuration, multiple layers, or a random winding pattern. As shown in FIG. 6A, the winding pattern of the wire can be arranged in a single layer. The axial density of the winding (e.g., how close each adjacent wire is to the next wire wrap) may affect the electromagnetic field strength within the conduit 108. In general, the more tightly wound the wire is, the greater the effect the transducer (winding) has on the water. If the transducer is not tightly wound such that there is space between the windings, the transducer may not generate as much heat, which can be beneficial in some embodiments.

FIG. 6B illustrates a multi-layer winding pattern. In this embodiment, the wire may be wound in a single layer along the conduit while a second layer can be wire over the first layer. The use of a plurality of wire layers may allow for a greater electromagnetic field density in a shorter distance, thus making the transducer more compact. This pattern may be useful when a limited amount of distance is available to place the transducer on the pipe. However, some amount of efficiency can be lost when multiple layers are used. This may require that the total length of the winding be somewhat longer than when a single layer is used.

FIG. 6C illustrates still another winding pattern. This pattern can include a somewhat random winding in a short distance, which can be referred to as being scramble sound in some instances. This winding pattern may be used to fill a predetermined winding area or space on the conduit, through the exact configuration of the windings may not be perfectly ordered. As with the use of multiple layers, the field strength within the windings can increase. While some amount of efficiency/field strength may be lost with the use of a multilayer configuration, the winding pattern has not been found to affect the overall transformation of the water to a significant degree.

In any of the embodiments described herein, the controller can include a number of components designed to create the alternating current through the transducer. As described herein, the controller 102 serves to provide electrical power to the transducer 706 at a desired voltage, frequency, and waveform. The controller 102 can comprise a number of components such as a transformer 702, a voltage regulator 704, and/or a waveform generator 708.

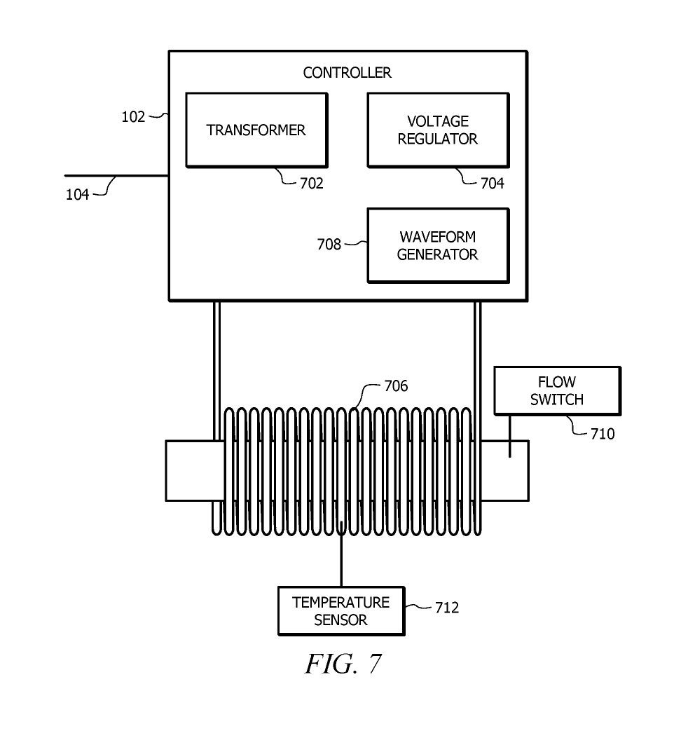

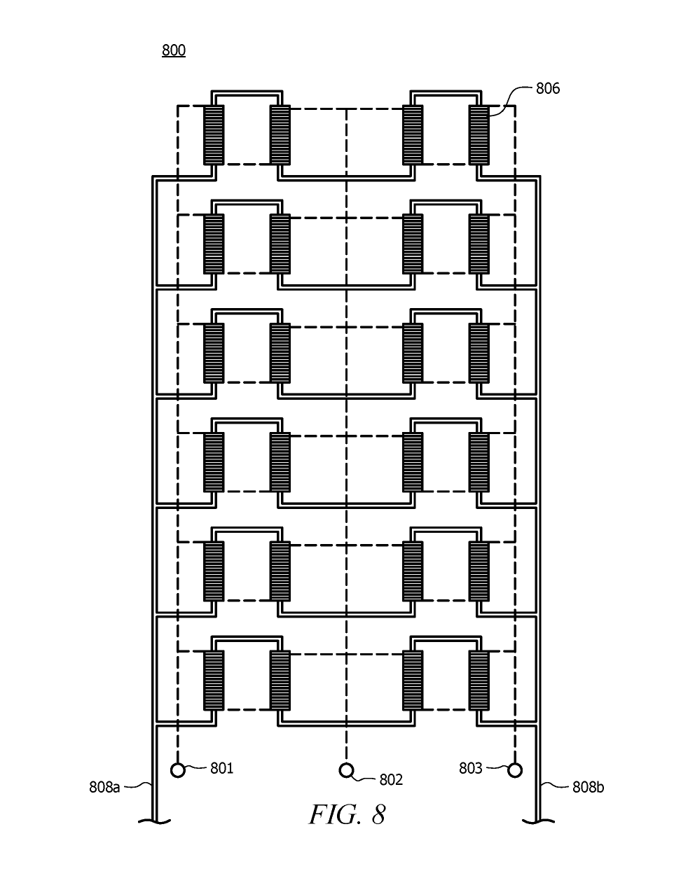

FIG. 7 schematically illustrates the components that can be present in the controller. In an embodiment, an inlet transformer 702 can be used to isolate the current from the inlet line. The transformer 702 can serve to provide a desired voltage if a voltage other than the line voltage is used with the transducer 706. In some embodiments, the transformer 702 can be eliminated so that the transducer is plugged directly into a standard wall socket, as described herein. For example, the transformer could be eliminated, and the controller could simply comprise a direct connection between a wall outlet and the transducer.

In an embodiment, the controller 102 can comprise a voltage regulator. The voltage regulator can be the same as the transformer, or a separate voltage regulator 704 can be used. The voltage regulator may be used in conjunction with the waveform generator 708 to produce a waveform for the current passing to the transducer 706. The waveform generator 708 can be used to generate a number of waveforms for the current. In an embodiment, the waveform generator 708 can generate a square wave at a desired frequency for use with the transducer 706. in some embodiments the wave form generator 708 can generate a sinusoidal waveform for use with the transducer 706. The waveform generator 708 can generate a steady frequency and waveform, or a variable frequency can be generated for the transducer. For example, a triangle wave having a multi-frequency spectrum can be generated for use with the transducer 706.

Various other components can be integrated with the controller 102. In some embodiments, safety equipment such as a flow switch 710, temperature sensor 712, or the like can be used with the transducer 706. The flow switch 710 and/or the temperature sensor 712 can be part of the controller 102 or they can be separate components. The flow switch 710 and/or temperature sensor 712, when present, may be coupled to a switch in the controller 102 to prevent power from being sent to the transducer 706 when the temperature exceeds a threshold and/or when the flow switch 710 indicates that the water is not flowing through the conduit 108.

In an embodiment, the flow switch 710 can be integrated into the conduit 108 at the inlet or outlet of the treatment device. When water flows through the conduit and contacts the flow switch, a signal can be generated in the flow switch 710 that activates the transducer 706. A flow switch 710 can be beneficial in preventing overheating of the conduit in the event that the transducer is turned on without any water flow to cool the transducer 706. The flow switch 710 may comprise a relay or a circuit with a phase control triac to turn on the transducer in the controller 102. For example, a magnetic reed switch can be used as the flow switch 710.

In an embodiment, a temperature sensor 712 such as a thermocouple can be used to detect the temperature of the transducer 706, the conduit 108, and/or the water exiting the treatment device. The temperature sensor 712 can be electrically coupled to a relay in the controller 102 and turn off the transducer in the event of a temperature being detected above a threshold.

In some embodiments, the device can be operated as a tuned loop when the controller comprises a capacitor in addition to any other control components. In general, a tuned loop can be caused to oscillate at its resonance frequency that depends on the relative inductance capacity of the transducer and the capacitive capacity of the capacitor. The driving frequency may be the same as or close to the resonance frequency. The operation of the treatment device as a tuned loop at the resonance frequency may produce a nearly sinusoidal waveform, and the amount of heating within the transducer may be reduced relative to the operation of the transducer in a non-tuned loop embodiments. The reduction in heating may also be advantageous in transferring the power that may otherwise result in heating of the transducer to treating the water.

In an embodiment, the treatment device can be configured as a tuned loop (e.g., a tank circuit) and operated at a frequency of about 2500 Hz applied to the transducer winding. The winding can have an LC resonance at the 2500 Hz by means of creating an L-C tank circuit out of the transducer with its associated parallel (resonant) capacitance across the transducer. The transducer can be excited by a 2500 Hz power square wave, and by the LC action of the parallel resonant tank, an approximate sine wave can be recreated across the transducer. The square wave can be generated electronically in a component of the controller that has a square wave oscillator whose output is then is applied to class D power V-MOSFETS, which essentially operate as simple switches from ground to Vdd. While the applied voltage can vary, approximately 48 volts can be applied to the drains to operate at a high output power level (e.g., at a current unit level of about 150 watts RMS). The resulting inputs to the tuned loop can include square waves and/or pulsed inputs to drive the circuit. While the tuned loop design is discussed in reference to specific values, the output device, the driving circuit, the resonance frequency, the inductance capacity, and the capacitive capacity are design factors that can be taken into consideration in designing the tuned loop circuit.

The controller in this embodiment can also comprise a fault detector. The fault detector can comprise a secondary winding wound around the transducer main winding. When the transducer is under proper excitation from the electronic unit, an RMS voltage (e.g., an approximate two-volt RMS voltage) can be induced in the fault detector winding. The fault detector winding output can be rectified and applied to a comparator, which is set to have an output should the input from the secondary sensing winding go away. This in turn provides an indication of a transducer fault (e.g. generating an alarm, lighting an indicator light, etc.). In some embodiments, fault detectors for a 60 Hz transducer can be formed by a simple secondary wound over the main transducer winding directly driving an indicator light. In this type of fault detector, the lack of a light indicates a non-functioning transducer. The 2500 Hz electronically excited transducer may find application in the generation of long term stable conditioned water.

In an embodiment, the treatment device can be used with a variety of voltage sources. In an embodiment, a 120 V AC current source can be used. In some embodiments, higher voltage sources can be used, for example, for larger volumetric applications. FIG. 8 schematically illustrates an embodiment of a treatment device using a 240 V AC, three-phase power source. In order to handle larger water throughputs, a supply header 808a can supply water to one or more treatment legs. While six treatment legs are illustrates, less than six treatment legs or 7 or more treatment legs can be used to scale the water throughput for the treatment device 800.

Each treatment leg may comprise four transducer 806 sections, which can be similar to or the same as any of the transducer sections described herein and can be used with a 240 V AC power supply. A central electrical connection 802 can be coupled to two supplies 801, 803. For each leg, the first two transducer sections are coupled to the first supply 801 and the central line 802, while the second two transducer sections are coupled to the second supply 803 and the central line 802. As an example, when the supply voltage is 240 V AC with three-phase power, a 120 V AC differential is created between each of the supply lines 801, 803 and the central line 801. In this example, each transducer section on each treatment leg may then have a voltage of 60 V AC applied. This embodiment may allow currents between about 10 amps to about 100 amps to be used with the treatment device 800. A higher voltage power supply could also be used (e.g., 480 V AC) where the transducer sections could be divided to provide a similar voltage per section (e.g., four or more transducer sections per treatment leg for a 480 V supply). Thus, as demonstrated by the embodiment shown in FIG. 8, relatively large power throughputs can be achieved for larger water throughputs, which may be useful for some uses such as agricultural watering.

The conditioned water resulting from using any of the embodiments described herein can be used for any number of uses. For example, the conditioned water can be used for drinking water, various culinary uses, agriculture, chemical preparation, and industrial uses. In an embodiment, the conditioned water can be used as drinking water or in other potable uses. As noted above, the conditioned water may have fewer dissolved solids and an increased pH. It has been found that treatment units operating at frequencies greater than 2 kHz or greater produce conditioned water having an improved taste relative to treatment units using a lower operating frequency. In addition, the drinking water treatment units may operate with a recycle configuration to produce additional changes in the water as compared to the changes achieved with a single pass. The conditioned water can then be used for drinking water or bottled water. The conditioned water can also be used in some uses in which scaling is problem such as coffee makers or cooking. Larger units may be useful on a household scale to prevent scaling in the pipes and hot water heaters. In this regard, the treatment device may be useful in replacing water softeners. In some embodiments, the conditioned water can be combined with food ingredients. For example, the conditioned water can be combined with soft drink additives. The use of the conditioned water may allow fewer ingredients to be used to obtain the same taste result.

The conditioned water can also be used for agricultural uses on both a home scale as well as commercial agricultural applications. In some embodiments, the use of the conditioned water can absorb better into soils and plants to result in faster growth.

For example, the use of the conditioned water may allow the efficiency of the water penetration and uptake to increase relative to untreated water. Such a use may allow plants watered with the conditioned water to be more resistant to insects and extreme weather. This may provide an extended growing seasons because the plants are better able to withstand heat and cold and increased plant production and yield. Treated water could also have potential applications for healthier and longer living marine life. The conditioned water can be used with any types of plants including rice, hay, corn, wheat, nuts, fruits, or any other crops.

When used in agriculture, the conditioned water may be used to treat all of the water used for irrigation or only a portion of the water used. For example, a portion of the water can be treated and the resulting conditioned water can be mixed with untreated water prior to being used for irrigation. The combination of the conditioned water with untreated water may allow the properties of the mixture to be controlled for purposes of irrigation. In addition, the conditioned water may be used throughout a growing season or only for a portion thereof. For example, the conditioned water may be used at the beginning of the growing season to allow seeds to germinate and sprout, and new plants to be better established with a faster growth rate. Once the plants are established, the amount of conditioned water can be decreased, if used at all, for the remainder of the growing season.

In some embodiments, the treatment device can be used to reduce the total dissolved solids content of the water for use in commercial applications. For example, the treatment device may be used in cooling tower applications. The conditioned water may have a decreased total dissolved solids content as well as a reduced calcium content, both of which can result in the formation of scale in cooling tower heat exchangers.

Additional commercial uses can include the preparation of certain chemicals. Any chemicals sold as part of an aqueous solution may have the chemical properties affected by the composition of the water used to form the solution. In some situations, chemical produces may use reverse osmosis to prepare relatively pure water. The use of the treatment device described herein may allow the conditioned water to be used in the chemical preparation as well as the final chemical solution. Further, the resulting pH increase may be beneficial in some chemical applications.

To further illustrate various illustrative embodiments of the present invention, the following examples are provided.

### EXAMPLES

The disclosure having been generally described, the following examples are given as particular embodiments of the disclosure and to demonstrate the practice and advantages thereof.

It is understood that the examples are given by way of illustration and are not intended to limit the specification or the claims in any manner.

### Example 1

In order to demonstrate the effects of the treatment systems described herein, a treatment system was constructed and used to treat several samples of water, which were tested to illustrate the relative changes caused by the treatment device. The system used in this Example was designed to condition tap water for drinking and mixing soft drinks like coffee, tea, etc. The transducer operated as a resonant system, operating at an alternating current frequency of approximately 2500 hertz. The system was designed to recirculate water through the transducer based on time signals from a programmable seven-day digital timer, which identically recycled each week. The system was configured so that water called for from the kitchen tap or outlet would be supplied by an accumulator storage tank under a pressure determined by the setting of a differential pressure switch. When enough water was drained from the accumulator storage tank, the differential pressure switch would actuate the pump and by means of solenoid valves, water from a large storage tank would be pumped into the accumulator tank and the kitchen supply piping under pressure. When the kitchen water demand had ceased, the pump would continue to pump up the pressure in the accumulator storage tank until it reaches the setting of the differential pressure switch and stop the pump.

When the digital timer calls for recirculation of the water during the timing cycle, The timer caused the pump to start and by means of solenoid valves caused the water to pass through the transducer before passing back to the storage tank. The transducer was activated by the timer so that the water would pass through the transducer to be conditioned during the recirculation cycle. When the time cycle was complete, the unit went into a rest mode until the kitchen demanded water or the next time cycle was initiated. If at any time during the recirculation timing cycle the kitchen had a water demand, the recirculating timing cycle was overridden by the kitchen water demand, triggered by a signal from the differential pressure switch. By means of a system of solenoid valves, the water was redirected from the pump outlet through the transducer and then to the accumulator storage tank and kitchen supply piping. When the kitchen demand had ceased, the pump would run until the differential pressure switch sensing accumulator tank pressure stops the pump. At that time the system again reverted to recirculating water to complete its set time cycle based on the time signals from the digital timer. If the recirculation timing cycle had completed before the kitchen demand had ceased, upon that cessation of the kitchen demand the unit went into its rest mode.

The water level was maintained at the proper operating level in the storage tank by means of four float switches. There was an overflow safety switch which caused the supply solenoid valve to close in event of a failure mode, a low level float switch which powered down the entire system in event of low water in the storage tank. Last there were two float switches arranged to cause the water fill solenoid valve to open and close in response to the high and low level float switches to keep the storage tank at the proper operating level.

Water samples were sampled and then passed through this system setup. Water samples were analyzed prior to treating the water (sample A1, sample B1, and sample C1) and subsequent to treating the water to produce conditioned water (sample A2, sample B2, and sample C2, respectively). Sample A1 was well water from Kerr Country, TX; sample B1 was water from Santa Barbara, Calif.; and sample C1 was raw water from Kerrville, Tex. The water samples were analyzed for various components, such as dissolved total solids, cations, anions, and hardness, by Texas Plant & Soil Lab, Edinburg, Tex. The total soluble salt content was measured as electrical conductivity (EC [mmhos/cm]), and the total dissolved solids were estimated from the EC values. Sodium Adsorption Ratio (SAR), which describes the proportion of sodium to calcium and magnesium in the water sample, was estimated from the levels of sodium, calcium and magnesium. The results of the water analysis are displayed in Table 1.

| | | Sample # | | | | | | | | | |
|---|---|---|---|---|---|---|---|---|---|---|---|
| | | | | | | | | | | | Average |
| Tested | | | | % | | | % | | | % | % |
| Parameter | | A1 | A2 | change | B1 | B2 | change | C1 | C2 | change | change |
| Total Soluble Salts | | 1.4 | 1.332 | −4.9 | 2.2 | 2.17 | −1.4 | 0.568 | 0.451 | −20.6 | −8.9 |
| EC [mmhos/cm] | | | | | | | | | | | |
| Total Dissolved | | 896 | 852 | −4.9 | 1408 | 1389 | −1.3 | 364 | 289 | −20.6 | −9.0 |
| Solids | | | | | | | | | | | |
| pH | | 7.79 | 8.28 | 6.3 | 7.73 | 7.65 | −1.0 | 8.01 | 8.37 | 4.5 | 3.2 |
| SAR | | 1.5 | 1.43 | −4.7 | 2.74 | 3.02 | 10.2 | 0.31 | 0.71 | 129.0 | 44.9 |
| Cations | Sodium Na | 80 | 75 | −6.3 | 169 | 188 | 11.2 | 13 | 23 | 76.9 | 27.3 |
| [ppm] | Calcium Ca | 74 | 74 | 0 | 123 | 111 | −9.8 | 68 | 32 | −52.9 | −20.9 |
| | Magnesium | 86 | 81 | −5.8 | 99 | 111 | 12.1 | 32 | 28 | −12.5 | −2.1 |
| | Mg | | | | | | | | | | |
| | Potassium | 22 | 20 | −9.1 | 7 | 13 | 85.7 | 5 | 5 | 0.0 | 25.5 |
| | K | | | | | | | | | | |
| Anions | Carbonate | 0 | 3 | N/A | 0 | 0 | N/A | 6 | 3 | −50.0 | −50.0 |
| [ppm] | CO₃ | | | | | | | | | | |
| | Bicarbonate | 275 | 293 | 6.5 | 525 | 297 | −45.3 | 305 | 226 | −25.9 | −21.6 |
| | HCO₃ | | | | | | | | | | |
| | Sulfates | 186 | 216 | 16.1 | 426 | 284 | −33.3 | 45 | 20 | −55.6 | −24.3 |
| | SO₄ | | | | | | | | | | |
| | Chlorides | 12 | 45 | 275.0 | 321 | 377 | 17.4 | 14 | 12 | −14.3 | 92.7 |
| | Cl | | | | | | | | | | |
| | Nitrates | 0.15 | 0.18 | 20.0 | 0.67 | 2.97 | 343.3 | 0.19 | 0.07 | −63.2 | 100.0 |
| | NO₃ | | | | | | | | | | |
| Other | Boron | — | — | — | 0.8 | 0.09 | −88.8 | — | — | — | −88.8 |
| Elements | B | | | | | | | | | | |
| | Manganese | — | — | — | 0.83 | 0.04 | −95.2 | — | — | — | −95.2 |
| | Mn | | | | | | | | | | |
| | Zinc | — | — | — | 0.01 | 0.01 | 0.0 | — | — | — | 0.0 |
| | Zn | | | | | | | | | | |
| | Copper | — | — | — | 0.01 | 0.06 | 500.0 | — | — | — | 500.0 |
| | Cu | | | | | | | | | | |
| | Iron | — | — | — | 0.32 | 0.07 | −78.1 | — | — | — | −78.1 |
| | Fe | | | | | | | | | | |
| Hardness | [mg/mL] | 536 | 517 | −3.5 | 715 | 732 | 2.4 | 301 | 194 | −35.5 | −12.2 |
| CaCO₃ | [grains/gal] | 31 | 30 | −3.2 | 42 | 43 | 2.4 | 18 | 11 | −38.9 | −13.2 |

Regarding the data in Table 1, a negative % change represents a decrease in a particular parameter, while a positive % change represents an increase in a particular parameter. Overall, under treatment, the levels of calcium, carbonate and bicarbonate decreased, probably owing to the formation of a calcium carbonate precipitate. The formation of calcium carbonate precipitate also led to an overall decrease in hardness. The level of magnesium also decreased overall under treatment, probably owing to the formation of magnesium hydroxide precipitate. With precipitating solids (e.g., calcium carbonate, magnesium hydroxide, etc.), the total soluble salts level decreased as well under treatment. SAR increased upon treatment, which can be expected given the decrease in calcium and magnesium, coupled with an observed increase in sodium levels. An overall increase in sodium, potassium, nitrate, and chloride levels could be attributed to salt dissociation equilibriums shifting due to precipitating of certain salts and/or due to a change in pH. The pH increased overall, which may have been caused by CO_{2(g)} leaving the water, thereby shifting the carbonic acid equilibrium towards consuming hydronium ions. The production of a calcium carbonate precipitate and CO_{2(g)} may have contributed to a decrease in calcium and bicarbonate levels. B, Mn, Zn, Cu and Fe levels were only tested for samples B1 and B2. The levels of Zn ad Cu were extremely low, probably approaching the detection limit of the instrument, and as such the variations in Zn and Cu as displayed in Table 1 might not be significant. The levels of B, Mn, and Fe decreased under treatment, indicating that some of these elements probably also formed insoluble precipitates, such as for example calcium hexaboride, manganese carbonate, iron hydroxide, iron phosphate, etc.

### Example 2

An embodiment of the treatment device was constructed with the following specifications: 30 inches of 1.5 inch schedule 40 PVC pipe, wound with no. 16 gauge wire, cut into 4 sections and coupled for space and efficiency. The water flow rate was about 25-gallons per minute. This is thought to be an adequate embodiment for a household unit. A 1-inch water meter from the city usually provides about 30 gallons/minute, so the unit would slow the flow a little because it can only handle 25 gallons/minute. If the lawn is watered at 25 gallons/minute, this still leaves 5 gallons/minute from the city to flush the toilet at the same time. If the city flow is larger than the unit flow, the unit will restrict the flow and decrease the water pressure, but the unit would not be damaged.

### Example 3

In another example of the device, ½ (half) inch schedule 40 PVC pipe having a length of 24 inches with a transducer made of 24-gauge wire with a close-wound winding length of about 18 inches was used, and the power applied was 20 watts at varying frequencies. A further embodiment of the device used 1.5 inch schedule 40 PVC pipe with a transducer made of no. 16-gauge wire with a total length of 100-120 inches, 500 watts of power was applied to it to condition the water for agricultural purposes with one pass. For industrial purposes, such as for used frac water or waste water, a device with a transducer of no. 6-gauge wire wound over several 12-foot length of pipe, 4 inches or 6 inches in diameter, with many kilowatts of power applied to it might be used.

### Example 4

Treated water was used on tomato plants that were planted on Mar. 1, 2014, in Kerrville, Tex., about 1-2 months earlier than normal. The tomato plants survived four freezes, grew to over six feet tall, and were still producing tomatoes in the middle of July. Tomato plants rarely survive a freeze because they prefer warm to hot temperatures. When referring to a freeze, the temperatures are usually around 30-32 degree Fahrenheit. Treated water that had a pH of about 8.5, which means the water underwent about 30 passes through the device, was also used to grow blueberries in Kerrville, Tex. The blueberry plants were still producing fruit in the middle of July.

### Example 5

For agricultural purposes such as for use in an irrigation pivot, the necessary flow rate of water would probably be about 400 gallons per minute or greater. The transducer would be made of no. 12 gauge wire for about a 30 foot pipe. Some pivots provide 900 gallons of water per minute, and the device would require 6-inch diameter pipe with no. 6 gauge wire with 100 amps of power applied. The goal for pivot irrigation and other large-scale agricultural uses is a single-pass transducer or pivot sprayer that can irrigate 180 acres at a time.

### Example 6

In order to further demonstrate the effects of the treatment systems described herein, a treatment system was constructed and used as previously disclosed herein to treat several samples of water, which were tested to illustrate the relative changes caused by the treatment device. More specifically, the effect of the treatment system on the pH, conductivity, resistivity, and resistance were investigated for various water samples, for single pass and multiple pass through the treatment system, and the resulting data is displayed in Table 2. The pH was measured with a pH meter that was calibrated prior to use; and the conductivity was measured with a voltmeter set to collect the DC Voltage pass when samples of water were used as a resistor in the process. Sample #1 was a control sample of untreated water: this particular sample was not passed through the treatment system. Sample #2 was obtained by passing the untreated water through the treatment system in a single pass. Sample #3 was obtained by softening the untreated water and then passing it through the treatment system in a single pass. Sample #4 (e.g., 50 gallons setup) and sample #5 were obtained by passing the untreated water through the treatment system in a multiple pass. Sample #3 was the only sample subjected to removal of calcium and magnesium ions prior to passing it through the treatment system; no other samples were softened pre-treatment (e.g., prior to passing through the treatment system).

TABLE 2

Tested Parameter

| | | Conductivity | Resistivity | |
|---|---|---|---|---|
| | | Change | Change | Resistance |
| Sample # | pH | [ohms⁻¹] | [ohms] | [ohms] |
| 1 | 7.27 | N/A | 0 | 0.52 |
| 2 | 7.46 | 14.29 | 0.07 | 0.59 |
| 3 | 7.94 | −12.50 | −0.08 | 0.44 |
| 4 | 8.31 | 8.70 | 0.115 | 0.635 |
| 5 | 8.26 | 5.88 | 0.17 | 0.69 |

The data in Table 2 indicate that by passing water through the treatment system as disclosed herein there is an increase in pH and in general an increase in resistivity; and a decrease in conductivity. The results in Table 2 suggest that the treatment system as disclosed herein is activating the water to shift its equilibrium to form more water molecules (H₂O) than its ionic counterparts (H⁺ and HO⁻).

pH Analysis. By increasing the number of passes through the treatment system as disclosed herein, there is an increase in pH, thereby reducing the ionic product of water (K_{w}) from 2.88×10⁻¹⁵ for sample #1 to 2.40×10⁻¹⁷ for sample #4. The K_{w} decreases by one order of magnitude from sample #1 to sample #3; and the K_{w} decreases by two orders of magnitude from sample #1 to sample #4. Without wishing to be limited by theory, passing water through the treatment system as disclosed herein may lead to effectively reducing the number of H⁺ and HO⁻ ions in solution and pushing these ions to the undissociated H₂O structure based on the equilibrium depicted in equation (7):

H₂O [symbol] H⁺+HO⁻ (7)

Temperature variations also affect the equilibrium in equation (7), wherein an increase in temperature (e.g., high temperature) shifts this equilibrium towards the right side (e.g., dissociation of water molecules into H⁺ and HO⁻ ions), and wherein a decrease in temperature (e.g., low temperature) shifts this equilibrium towards the left side (e.g., formation of water molecules from H⁺ and HO⁻ ions). For example, at 25° C., at a pH of 7, K_{w}=1.0×10⁻¹⁴. Further, as another example, at 0° C., K_{w}=1.5×10⁻¹⁵. Further, as yet another example, at 60° C., K_{w}=9.5×10⁻¹⁴. As will be appreciated by one of skill in the art, and with the help of this disclosure, a higher temperature contributes to a higher K_{w}.

Conductivity Analysis. Generally, resistivity increases with decreasing the number or amount of ions in solution, and conductivity follows the reverse trend by generally decreasing with decreasing the number or amount of ions in solution. This is evident in the softened water (sample #3), where Mg²⁺ and Ca²⁺ ions (which are present in samples #1 and #2) are no longer present (or have been substantially removed). Conductivity decreases for sample #3 because in addition to the treatment system reducing the number of H⁺ and HO⁻ ions in solution by shifting the equilibrium in equation (7) towards the undissociated water molecule, the Mg²⁺ and Ca²⁺ ions are also removed from the water sample, thereby reducing the conductivity of the overall system. Conductivity continues to decrease with multiple pass systems (samples #4 and #5) because of ions (e.g., Mg²⁺ and Ca²⁺ ions) potentially precipitating out of the solution (e.g., water sample). When a water sample is softened by ion exchange, the Mg²⁻ and Ca²⁺ ions are usually replaced with Na⁺ ions, and this process does not usually affect the overall conductivity; however, in this case, the conductivity can be decreased owing to reducing the number of H⁺ and HO⁻ ions in solution by shifting the equilibrium in equation (7) towards the undissociated water molecule.

Single Pass Comparison. The softened water (sample #3) has a higher pH, most likely due to the ions (Na⁺) present in the sample #3 solution, as a result of softening the water. Without wishing to be limited by theory, a treatment system as disclosed herein could act on such a small ion (Na⁺) more effectively. pH goes up for sample #3 because there are more undissociated water molecules present than its ionic (H⁺ and HO⁻) counterparts, and the presence of Na⁺ ions can lead to a pH increase. As discussed previously herein for the conductivity, the treatment system as disclosed herein can lead to a decrease in the number of H⁺ and HO⁻ ions in solution by shifting the equilibrium in equation (7) towards the water molecule, thereby leading to a lower conductivity, and consequently a higher resistivity. The differences observed in pH and conductivity between the different single pass samples (samples #2 and #3) are most likely due to softening the water in sample #3. The conductivity increase for sample #2 can be attributed to an increased number of free ions in solution owing to the treatment system as disclosed herein activating the water to shift its equilibrium to form more undissociated water molecules (H₂O) than its ionic counterparts (H⁺ and HO⁻). Without wishing to be limited by theory, some ions in solution (e.g., sample #2) could be more mobile with respect to current flow due to a lower hydration of such ions.

Multi Pass Comparison. The multi pass samples #4 and #5 display a decrease in conductivity (and a consequent increase in resistivity) when compared to the single pass sample #2, probably owing to a higher degree of decrease in the number of H⁺ and HO⁻ ions in solution by shifting the equilibrium in equation (7) towards the water molecule.

Having described a number of systems and methods herein, specific embodiments can include, but are not limited to:

In a first embodiment, a treatment device for treating water with an electromagnetic field comprises: a conduit; a transducer comprising a wire coil positioned around an outside of a portion of the conduit; and a controller electrically coupled to the transducer, wherein the controller is configured to provide an alternating current to the transducer.

A second embodiment can include the device of the first embodiment, wherein the conduit comprises a plastic.

A third embodiment can include the device of the first embodiment, wherein the conduit comprises a non-ferromagnetic material.

A fourth embodiment can include the device of the third embodiment, wherein the conduit is formed from copper, aluminum, non-ferromagnetic stainless steel, any alloy thereof, or any combination thereof.

A fifth embodiment can include the device of any of the first to fourth embodiments, wherein the conduit comprises an electrically insulating coating, and wherein the electrically insulating coating is disposed between an outer surface of the conduit and the wire coil.

A sixth embodiment can include the device of any of the first to fifth embodiments, further comprising a power supply coupled to the controller, wherein the power supply is configured to provide an alternating current supply between about 12 V AC and about 480 V AC.

A seventh embodiment can include the device of any of the first to sixth embodiments, further comprising a recycle line, wherein the recycle line provide fluid communication between an outlet of the conduit downstream of the transducer and an inlet of the conduit upstream of the transducer.

An eighth embodiment can include the device of any of the first to seventh embodiments, further comprising an insulated enclosure, wherein the conduit and the transducer are disposed within the insulated enclosure, and wherein a size of wire in the wire coil is configured to generate heat in response to the alternating current being provided to the transducer.

A ninth embodiment can include the device of any of the first to eighth embodiments, wherein the wire coil comprises a single layer of windings about the conduit.

A tenth embodiment can include the device of any of the first to eighth embodiments, wherein the wire coil comprises a plurality of layers of windings about the conduit.

An eleventh embodiment can include the device of the tenth embodiment, wherein the plurality of layers are disposed in a random winding pattern.

A twelfth embodiment can include the device of any of the first to eleventh embodiments, wherein the controller comprises a capacitor, wherein the capacitor and the transducer form a tuned loop, and wherein the controller is configured to provide the alternating current to the transducer at a resonance frequency.

A thirteenth embodiment can include the device of any of the first to twelfth embodiments, further comprising a turbulence inducing structure disposed within the conduit.

A fourteenth embodiment can include the device of the thirteenth embodiment, wherein the turbulence inducing device comprises an insert within the conduit having a helical shape.

A fifteenth embodiment can include the device of any of the first to fourteenth embodiments, further comprising a flow switch, wherein the flow switch is configured to provide an indication to the controller when water is not flowing through the conduit.

A sixteenth embodiment can include the device of any of the first to fifteenth embodiments, further comprising a temperature sensor in thermal contact with the transducer and in signal communication with the controller, wherein the controller is further configured to prevent the alternating current from being provided to the transducer when a temperature detected by the temperature sensor exceeds a threshold.

In a seventeenth embodiment, a treatment device for treating water with an electromagnetic field comprises: a conduit; a multi-section transducer comprising a plurality of wire coils positioned around an outside of a portion of the conduit, wherein the plurality of wire coils are connected in series; and a controller electrically coupled to the multi-section transducer, wherein the controller is configured to provide an alternating current to each wire coil of the plurality of wire coils.

An eighteenth embodiment can include the device of the seventeenth embodiment, where the multi-section transducer comprises between 2 and 10 wire coils.

A nineteenth embodiment can include the device of the seventeenth or eighteenth embodiment, wherein the controller is configured to provide between about 20 V AC and about 80 V AC to each wire coil of the plurality of wire coils.

A twentieth embodiment can include the device of any of the seventeenth to nineteenth embodiments, wherein the conduit comprises at least one bend between each wire coil of the plurality of wire coils.

In a twenty first embodiment, a method of treating water comprises: passing inlet water through a conduit; subjecting the inlet water to a varying electromagnetic field within the conduit; changing at least one property of the inlet water within the conduit in response to the varying electromagnetic field; and producing a conditioned water.

A twenty second embodiment can include the method of the twenty first embodiment, further comprising: passing an alternating electrical current through a transducer, wherein the transducer comprises a wire coil disposed about at least a portion of the conduit; and generating the varying electromagnetic field within the conduit in response to the passing the alternating electrical current through the transducer.

A twenty third embodiment can include the method of the twenty second embodiment, wherein the conduit comprises a non-ferromagnetic material.

A twenty fourth embodiment can include the method of the twenty third embodiment, wherein the conduit comprises a metal, and wherein the method further comprises: generating heat while subjecting the water to the varying electromagnetic field; and conducting the heat into the water through the conduit.

A twenty fifth embodiment can include the method of any of the twenty second to twenty fourth embodiments, wherein the alternating electrical current is provided at a voltage between about 12 V AC and about 480 V AC.

A twenty sixth embodiment can include the method of any of the twenty second to twenty fifth embodiments, wherein the alternating electrical current is provided at a frequency between about 10 Hz and about 200 kHz.

A twenty seventh embodiment can include the method of any of the twenty second to twenty fifth embodiments, wherein the alternating electrical current provides between about 10 watts to about 10 kilowatts to the water.

A twenty eighth embodiment can include the method of any of the twenty second to twenty seventh embodiments, further comprising: heating the inlet water within the transducer.

A twenty ninth embodiment can include the method of the twenty eighth embodiment, wherein the conditioned water is at least about 5° C. warmer than the inlet water.

A thirtieth embodiment can include the method of any of the twenty first to twenty ninth embodiments, wherein the alternating electrical current is in electrical communication with a capacitor, and wherein the transducer and the capacitor are operated as a tuned loop at a resonant frequency.

A thirty first embodiment can include the method of any of the twenty first to thirtieth embodiments, wherein the conditioned water has a pH at least about 0.1 pH units higher than the inlet water.

A thirty second embodiment can include the method of any of the twenty first to thirty first embodiments, wherein the conditioned water has a TDS content at least about 10% lower than the inlet water.

A thirty third embodiment can include the method of any of the twenty first to thirty second embodiments, wherein the conditioned water has a hardness at least about 20% lower than the inlet water.

A thirty fourth embodiment can include the method of any of the twenty first to thirty third embodiments, wherein the conditioned water has an ORP at least about 20 mV lower than the inlet water.

A thirty fifth embodiment can include the method of any of the twenty first to thirty fourth embodiments, further comprising forming a precipitate in response to changing the at least one property of the inlet water.

A thirty sixth embodiment can include the method of any of the twenty first to thirty fifth embodiments, further comprising recycling the conditioned water to the inlet of the conduit one or more times.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as comprises, includes, and having should be understood to provide support for narrower terms such as consisting of, consisting essentially of, and comprised substantially of Use of the term “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

We claim:

1. A treatment device for treating water with an electromagnetic field, the device comprising:
a conduit;
a transducer comprising a wire coil positioned around an outside of a portion of the conduit; and
a controller electrically coupled to the transducer, wherein the controller is configured to provide an alternating current to the transducer.

2. The device of claim 1, wherein the conduit comprises a plastic.

3. The device of claim 1, wherein the conduit comprises a non-ferromagnetic material.

4. The device of claim 3, wherein the conduit is formed from copper, aluminum, non-ferromagnetic stainless steel, any alloy thereof, or any combination thereof.

5. The device of claim 1, wherein the conduit comprises an electrically insulating coating, and wherein the electrically insulating coating is disposed between an outer surface of the conduit and the wire coil.

6. The device of claim 1, further comprising a power supply coupled to the controller, wherein the power supply is configured to provide an alternating current supply between about 12 V AC and about 480 V AC.

7. The device of claim 1, further comprising a recycle line, wherein the recycle line provide fluid communication between an outlet of the conduit downstream of the transducer and an inlet of the conduit upstream of the transducer.

8. The device of claim 1, further comprising an insulated enclosure, wherein the conduit and the transducer are disposed within the insulated enclosure, and wherein a size of wire in the wire coil is configured to generate heat in response to the alternating current being provided to the transducer.

9. The device of claim 1, wherein the wire coil comprises a single layer of windings about the conduit.

10. The device of claim 1, wherein the wire coil comprises a plurality of layers of windings about the conduit.

11. The device of claim 10, wherein the plurality of layers are disposed in a random winding pattern.

12. The device of claim 1, wherein the controller comprises a capacitor, wherein the capacitor and the transducer form a tuned loop, and wherein the controller is configured to provide the alternating current to the transducer at a resonance frequency.

13. The device of claim 1, further comprising a turbulence inducing structure disposed within the conduit.

14. The device of claim 12, wherein the turbulence inducing device comprises an insert within the conduit having a helical shape.

15. The device of claim 1, further comprising a flow switch, wherein the flow switch is configured to provide an indication to the controller when water is not flowing through the conduit.

16. The device of claim 1, further comprising a temperature sensor in thermal contact with the transducer and in signal communication with the controller, wherein the controller is further configured to prevent the alternating current from being provided to the transducer when a temperature detected by the temperature sensor exceeds a threshold.

17. A treatment device for treating water with an electromagnetic field, the device comprising:
a conduit;
a multi-section transducer comprising a plurality of wire coils positioned around an outside of a portion of the conduit, wherein the plurality of wire coils are connected in series; and
a controller electrically coupled to the multi-section transducer, wherein the controller is configured to provide an alternating current to each wire coil of the plurality of wire coils.

18. The device of claim 17, where the multi-section transducer comprises between 2 and 10 wire coils.

19. The device of claim 17, wherein the controller is configured to provide between about 20 V AC and about 80 V AC to each wire coil of the plurality of wire coils.

20. The device of claim 17, wherein the conduit comprises at least one bend between each wire coil of the plurality of wire coils.

21. A method of treating water, the method comprising:
passing inlet water through a conduit;
subjecting the inlet water to a varying electromagnetic field within the conduit;
changing at least one property of the inlet water within the conduit in response to the varying electromagnetic field; and
producing a conditioned water.

22. The method of claim 21, further comprising:
passing an alternating electrical current through a transducer, wherein the transducer comprises a wire coil disposed about at least a portion of the conduit; and
generating the varying electromagnetic field within the conduit in response to the passing the alternating electrical current through the transducer.

23. The method of claim 22, wherein the conduit comprises a non-ferromagnetic material.

24. The method of claim 23, wherein the conduit comprises a metal, and wherein the method further comprises:
generating heat while subjecting the water to the varying electromagnetic field; and
conducting the heat into the water through the conduit.

25. The method of claim 22, wherein the alternating electrical current is provided at a voltage between about 12 V AC and about 480 V AC.

26. The method of claim 22, wherein the alternating electrical current is provided at a frequency between about 10 Hz and about 200 kHz.

27. The method of claim 22, wherein the alternating electrical current provides between about 10 watts to about 10 kilowatts to the water.

28. The method of claim 22, further comprising: heating the inlet water within the transducer.

29. The method of claim 28, wherein the conditioned water is at least about 5° C. warmer than the inlet water.

30. The method of claim 21, wherein the alternating electrical current is in electrical communication with a capacitor, and wherein the transducer and the capacitor are operated as a tuned loop at a resonant frequency.

31. The method of claim 21, wherein the conditioned water has a pH at least about 0.1 pH units higher than the inlet water.

32. The method of claim 21, wherein the conditioned water has a TDS content at least about 10% lower than the inlet water.

33. The method of claim 21, wherein the conditioned water has a hardness at least about 20% lower than the inlet water.

34. The method of claim 21, wherein the conditioned water has an ORP at least about 20 mV lower than the inlet water.

35. The method of claim 21, further comprising forming a precipitate in response to changing the at least one property of the inlet water.

36. The method of claim 21, further comprising recycling the conditioned water to the inlet of the conduit one or more times.
